(19) United States
(12) Patent Application Publication
(10) Pub. No.: US 2002/0166927 A1
(43) Pub. Date: Nov. 14, 2002

(54) Wrist rest for keyboards

(76) Inventor: Kevin J. Kollar, Ada, MI (US)

Correspondence Address: Christopher D. Harrington, c/o Knape & Vogt Manufacturing Company, 2700 Oak Industrial Drive NE, Grand Rapids, MI, 49505, US

(21) Appl. No.: 09/853,071

(22) Filed: May 10, 2001

(51) Int. Cl. B43L 15/00

(52) U.S. Cl. 248/118.1

(57) ABSTRACT

A wrist rest of the present invention comprises an elongate body with distal end portions, a front edge, a rear edge, a top portion, a central portion and a bottom. The central portion further compromises a web that is supportive of said top portion and in conjunction with the selection of a suitable polymeric resin, the wrist rest can be formed as one integrated article that possesses a nearly identical feel as is found in gel-filled wrist rests.

### FIELD OF THE INVENTION

The present invention relates to the field of wrist rests for use with keyboards, normally the kind associated with computer workstations and the like.

### BACKGROUND OF THE INVENTION

The present invention relates to wrist rests that are used in conjunction with keyboards that one may find in association with a computer, a cash register or any other application where the user is entering data or numbers. Wrist rests of this type generally follow a certain appearance or profile. They typically extend for most of the width of the keyboard area, and they have a cross-section that may be rounded or radiussed on the top in a general way, and the overall contour may be slightly elevated above the first row of keys on the keyboard.

There are other design attributes that are known in a wrist rest of this type, which include a convex shaped leading edge, (when viewed from the top) which conforms to the general approach that the user takes towards the center of the keyboard which is the shortest primary contact between the user and the keyboard. The convex curvature of the leading edge, therefore, may be an ergonomic consideration since the users are extending their arms at a greater distance from the central point, to reach the more extreme end positions on the keyboard. Additionally, in this position, the user's arms and hands are at the utmost extension and are stressed unduly. Thus, it is conceivable that additional supporting surface area would be desirable more near the ends of the keyboard.

The general form and appearance of the wrist rest is somewhat similar across the products that are known whereas the actual construction of these products, as it turns out, is not so similar. Products that the applicant has been exposed to include constructions such as monolithic extrusions, which result in a stiff and rigid product. Such a wrist rest presents with the typical form and appearance, however, it does not, by itself, provide much relief in terms of cushioning nor does it have any ability to conform its structure to the impression of the wrist or hand that may be resting on it.

Probably as a result of some of the foregoing deficiencies in the extruded version, it is known that the wrist rest of this type has been improved in some versions by the application of a softer material on top of the extruded base. This covering has a limited ability to impart “softness” or flexibility to the surface of the final product. Many times, therefore, these efforts to cushion the wrist rest are fairly superficial and do not achieve the desired degree of ergonomic effects for wrist support and forearm support.

Another version of this product is known where a very substantial number of sub-components are brought together; commencing with a wooden base, which is typically a plywood type material that is cut in the rough shape of a wrist rest. On top of this is placed a rubber or resilient plastic layer, and on top of this layer is applied a gel-material, such as a silicone based resin, or foam, that is mounded up in the general shape of the wrist rest product. Lastly, front and back support strips can be added, which then allow the whole composite structure to be covered with fabric. The fabric may be attached by stapling to the bottom of the wood base. In this fashion, the wrist rest product does have all the requisite functional benefits, including a very soft and cushioned support, that does not deform substantially thanks to the internal structure, and which also has a solid base material for fastening to the tray of a keyboard support or to a computer work station.

Yet another prior art version of a wrist rest is known where a base for the wrist rest is formed from a molded rigid plastic and a foam layer is applied over this. The resultant combination provides the requisite characteristics for a base including the compatible fastening of the base to a keyboard tray assembly, along with the requisite cushioning needed for the comfort of the user.

Before the advent of the present invention, numerous problems were associated with the foregoing designs. In some respects, the various design objectives were contrary, since it is necessary to have both a soft and cushiony material associated with a hard material; the former providing the desired support, and the latter providing the means for securing the product to the keyboard tray. Compromises in construction led, therefore, to less than perfect results, including wrist rests that were substantially too hard to fulfill users expectations, or in the alternative that were costly to manufacture and at times, unable to retain their form adequately over long periods of use.

Therefore, the compromises have been a long standing problem in the industry where the satisfaction of the user's requirements are either not completely met, or are met with only with cumbersome and costly versions of this particular product.

### SUMMARY OF THE INVENTION

The present invention, compromises a wrist rest which in accordance with the concepts more fully described below, is made from a monolithic plastic that has been injected molded to form an outer structure or skin that has the beneficial contours of a wrist rest, and an inner central structure or core that has a strategic web construction that substantially forms the central portion and the bottom portion of the wrist rest product.

Additional to the foregoing, the wrist rest of the present invention also includes pre-formed receivers for the receiving of fasteners to affix the wrist rest to a keyboard tray.

The present invention also comprises receiving slots on the distal ends of the product, for the compatible engagement of shrouding that may be associated with an adjustable keyboard tray device.

It is therefore, an object of the present invention to provide a wrist rest that is economical to manufacture and that provides all of the functionality that the user desires.

It is also an object of the present invention to produce a wrist rest product that retains its shape and form over the anticipated life of the product.

It is also an object of the present invention to provide a wrist rest for use with keyboards and the like, that can be precisely produced with a contour and where said contour is retained in each such product that is manufactured thereafter.

These and other objects of the present invention will become more fully realized as they are explained below.

### BRIEF DESCRIPTION OF THE DRAWINGS

FIG. 1 illustrates a perspective view of the wrist rest of the present invention installed on a keyboard tray.

FIG. 2 is a top plan view of the wrist rest of the present invention.

FIG. 3 is a front view of the wrist rest of the present invention showing the front edge.

FIG. 4 is a bottom view of the wrist rest of the present invention, showing the web structure and the provision for receivers.

FIG. 5 is a side view showing one of the ends of the wrist rest of the present invention.

FIG. 6 is a front perspective view of a mouse pad embodying the present invention.

FIG. 7 is a side elevation view of the mouse pad shown in FIG. 6.

FIG. 8 is a bottom view of the mouse pad shown in FIG. 6.

### DETAILED DESCRIPTION OF THE PREFERRED EMBODIMENT

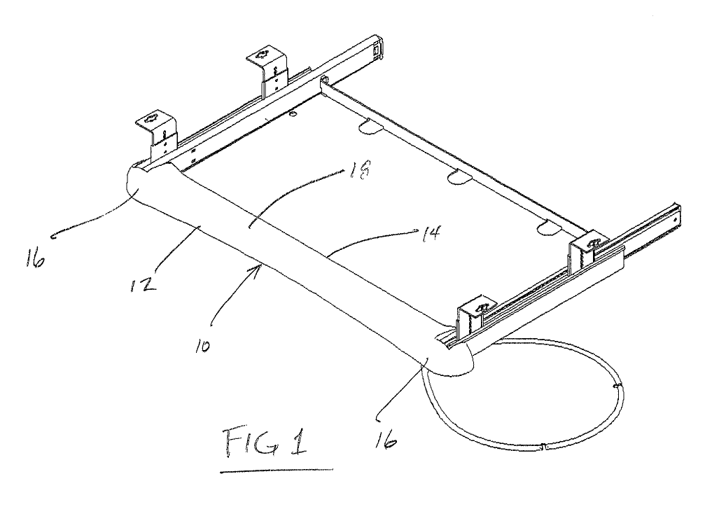

A new wrist rest in accordance with the present invention is shown generally in FIG. 1 in association with a keyboard tray assembly. The keyboard and the keyboard tray itself are not specifically a part of the present invention and are shown for the purpose of illustration only.

The wrist rest 10 of the present invention is shown in the installed position on a keyboard tray. The wrist rest includes front edge 12, rear edge 14, ends 16 and the top 18.

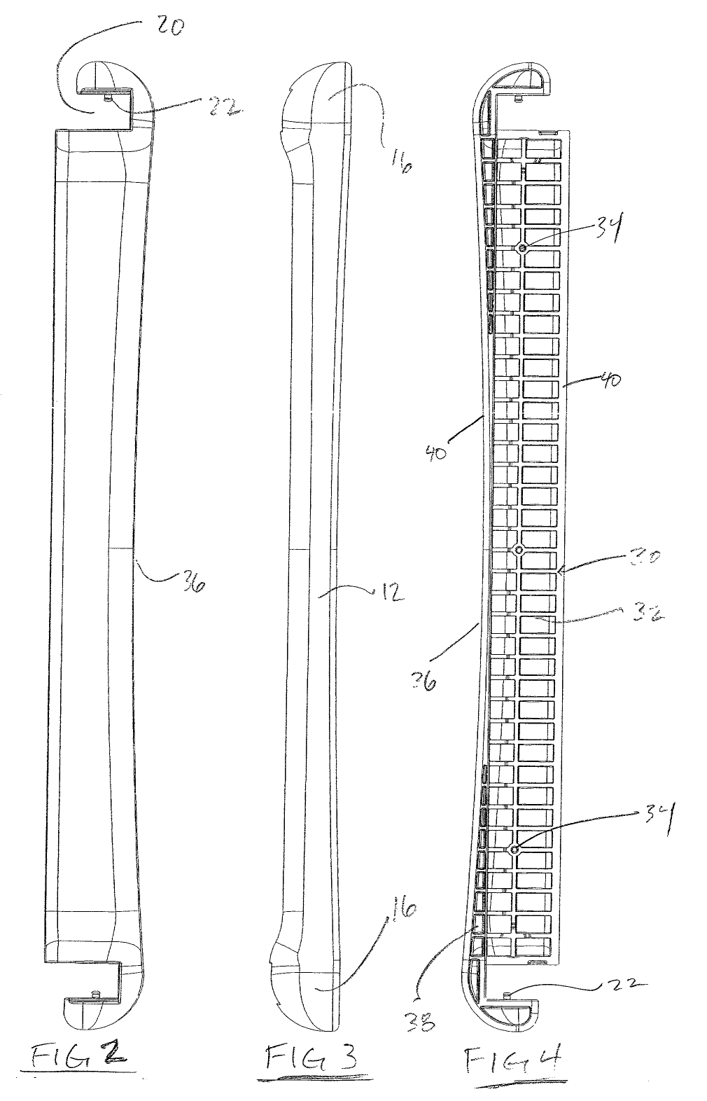

Turning now to FIG. 2, a top view of the wrist rest of the present invention is shown. The slot 20 can be seen as well as the projection 22, which emanates from one of the sidewalls of the slot area.

FIG. 3 shows a front view of the present invention with the sculpted or contoured appearance. The ends 16, generally terminate in a more bulbous type of configuration, which is a consequence of the need for forming the slot. This requirement will be discussed in more detail below.

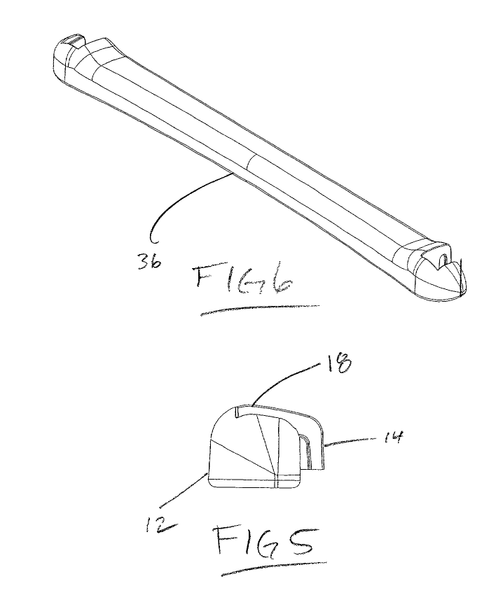

FIG. 4 shows a more detailed area of the wrist rest as viewed from the bottom. In this view, the bottom 30, is shown with the web 32, the receivers 34, the radius 36 and the end webbing 38. As may be appreciated from the drawing, the web that forms the central portion of the wrist rest is styled somewhat in a grid pattern, although it is understood that it could take other forms such as a diamond pattern or a honeycomb, whichever would be convenient and suitable for injection molding and would still leave the surface or skin of the final product with the desired degree of cushioning. The end webbing 38, is a consequence of the design of the end portion of the wrist rest and again it could conceivably take different forms, as is the case for the central web portion. It is also understood that the present invention may take other forms, including the conventional appearance of a wrist rest, without the end slots being incorporated into the product at all. The important thrust, with respect to the webbing, is that it provides suitable structure for maintaining the exterior configuration of the wrist rest, while at the same time, avoiding the rigidity of a solid, monolithic construction, yet it provides a means for the secure fastening of the wrist reset to a keyboard tray assembly.

The web construction forms substantially the interior portion of the wrist rest of the present invention. As may be appreciated from the view in FIG. 4, the outer skin 40 of the wrist rest remains substantially the same thickness from the front edge to the top to the rear edge of the wrist rest itself. The actual thickness will vary depending on the characteristics of the plastic resin selected, however, in the preferred embodiment; it ranges from 0.06″ to 0.2″. The effect that is imparted is that when one views the product from the top is that it looks and feels substantially similar to the gel filled wrist rests that are commonly known in the industry. The usage of the web to form the core or bulk of the wrist rest does generate an illusion of sorts, in that the mechanical rigidity is intentionally sacrificed to a select level in order to gain the softness of the contact between the user and the surface of the wrist rest. Thus, in a very real way, the wrist rest of the present invention simulates the functional attributes of the gel filled wrist rest without any of the detriments in having a multi-component structure or without having to use the silicone based resins to form the core of the product

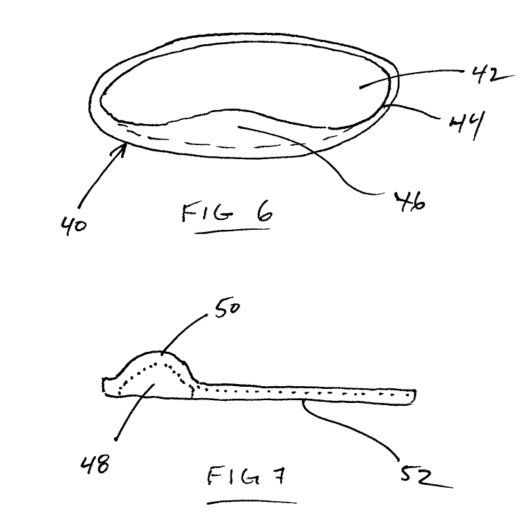

Turning now to FIG. 5, a side view of the present invention is shown with the top 18 more clearly revealing the shape of the contour running from the front edge to the rear edge. The contour itself is generally selected to eliminate any “sharpness” in contact by the user, while at the same time maintaining an overall elevation from bottom to top that would be appropriate for elevating the wrist and forearm area just slightly above the front portion of an actual computer keyboard. Additionally, the rearward portion of the contour as can be seen in FIG. 5, has a longer slope and is angled downwards. This feature has been specifically added to the present invention. The downward or negative inclination is consistent with the objective of some keyboard tray designs that position the keyboard itself in a negative inclination. It is believed that biomechanical stressors are reduced in this manner and this results in a product that is better suited to the user, and to the conditions of use.

Further explanation of features of the present invention include the basis for the gentle convex radius 36, which is shown in FIG. 4. As briefly alluded to above, this radius is a desired treatment for the wrist rest in terms of matching to a modest extent, the arc of the access to the user who is usually seated in alignment near the center of the keyboard.

Additionally, the ends, which incorporate the slots, are provided in the present invention for increased utility of the wrist rest. In this case, and as is consistent with keyboard tray assemblies of the type shown, the wrist rest is able to conform around the front edge of that portion that comprises part of the keyboard tray assembly. This is not only a cosmetic feature which tends to integrate the wrist rest into the overall product, but it provides a functional purpose in that it guards against exposure to any edges which may have burrs or sharpness to them. Obviously, the slot provides the area for receiving the shrouding element, while the projection 22 operates as a means to engage the wrist rest with the keyboard tray assembly by pushing or sliding the projection into a through hole or slot appropriately oriented in the shrouding.

In a variation on this embodiment, it is within the scope of the present invention to mold a skin over the open area of the slots, thereby enclosing the slots and substantially hiding them from view once installed.

The wrist rest of the present invention is actually constructed from resilient plastic resins that are injection molded into the desired form. The actual selection of the resin is dependent upon factors such as the need for sufficient strength or rigidity, and compatibility with achieving the soft touch that is generated by the usage of the supporting web.

It should also be noted that the selection of the plastic resin for use in the wrist rest of the present invention, is preferably a PVC (polyvinyl chloride) that can be selected from a range of PVC resins that have sufficient rigidity for providing the necessary strength in the receivers for receiving fasteners, at the same time with enough resilient flexibility to impart the cushioning effect when constructed as described herein, and which simulates the feel of the gel filled wrist rest. It is also understood that other plastic resins will achieve some or all of these attributes as well, to one degree or another, although the preferred resin material is a type of PVC of hardness in the range of 40-70 shore A durometer.

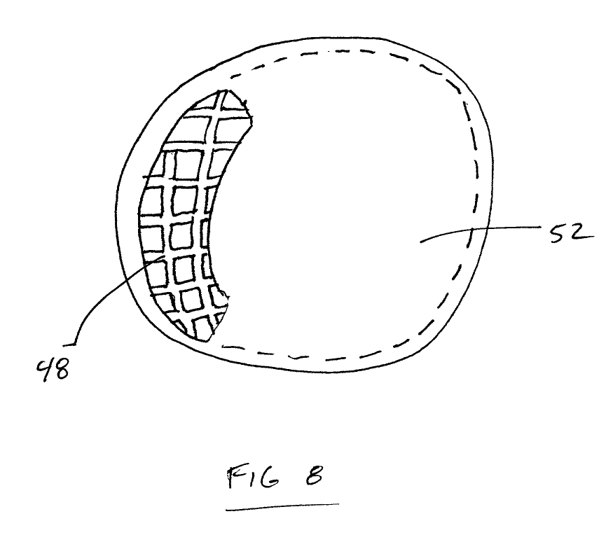

Turning now to FIGS. 6, 7, and 8, another embodiment of the present invention is shown whereby the usage of a select polymeric resin and a strategic web is combined to form a mouse pad with an integrated wrist rest.

Specifically, the mouse pad 40 is comprised of the mouse area 42, rim 44, rest 46, web 48, reset top 50 and mouse pad bottom 52. Further, the view in FIG. 8 shows in more detail, the web 48 that substantially occupies the central portion of the rest 46 features. The mouse pad bottom is shown as a flat surface in this figure but it could just as easily be provided with a textured surface.

The mouse pad of this embodiment possesses the same wrist rest characteristics as described above, albeit on a scale consistent with the mouse pad itself. In this version though, it is preferentially desirable to cover the mouse area and the reset top with a fabric or to apply a texture in order to ensure mouse function and to enhance the cosmetics of the product this treatment is superficial and would not detract from the fundamental attributes associated with the present invention.

With the foregoing in mind, the present invention and reasonable variations on its embodiment, define for the first time a wrist rest that avoids the usage of the silicone or other gel resins and yet still achieves the effects of the gel filled wrist rest product. This is important in terms of advancing the art in this area and avoiding the complexities of construction and manufacturing of the gel filled wrist rest products. In addition, it is also believed that the usage of the silicone resins presents other problems, which have not been fully addressed in the art. It is believed that at times they do not cure as well when they are formed up in thicker applications, such as the wrist rest, and additionally there are functional limitations in manufacturing these prior art wrist rest that can be improved by resort to the injection molded species of the present invention. As a result, the usage of the present invention provides a much higher degree of functionality then the product it is designed to replace.

These and other attributes of the present invention and enhancements or variations that can be practiced by one skilled in the art, are claimed by the inventor:

I claim:

1. A wrist rest for use with keyboards or for data entry comprising:
An elongated plastic body with distal end portions, a front edge, compatibly contoured to support the wrist(s) of a user, a rear edge and a top surface, where said top surface is flexibly resilient;
A center portion of said plastic body comprising a web structure;
A bottom portion of said body comprising the bottom of said web.

2. A wrist rest of claim 1, wherein the bottom of said web structure further includes receivers for fasteners.

3. A wrist rest of claim 1, wherein the plastic body comprises a polyvinyl chloride.

4. A wrist rest of claim 1, wherein the top surface comprises a skin that extends from said front edge to said rear edge and from one distal end to the other distal end, and where said skin is substantially of uniform thickness.

5. A wrist rest of claim 1, wherein the distal ends include integration means for incorporating said wrist rest with the structural elements of a keyboard tray assembly.

6. A wrist rest of claim 5, wherein said integration means also includes an attachment means for engaging the wrist rest to the structural elements of a keyboard tray assembly.

7. A wrist rest for use with keyboards or for data entry, where said wrist rest includes a body with distal end portions, a front edge, a rear edge, a top surface, a central portion and a bottom, the improvement therein comprising the fabrication of said wrist rest from a polymeric resin where said central portion and said bottom compromise a web, where said polymeric resin is selected to impart flexible resiliency to the top surface of the wrist rest.

8. A wrist rest of claim 7, wherein the bottom includes fastening means for fastening the wrist rest to a keyboard tray assembly.

9. A wrist rest of claim 7, wherein the polymeric resin is a polyvinyl chloride

10. The process for constructing a wrist rest including the steps of: employing a mold with provisions for forming an elongate body, wherein said elongate body includes distal end portions, a front edge, a rear edge, a top surface, a central portion and a bottom portion, and further, where said central portion and said bottom portion are comprised of a web structure; injecting said mold with a polymeric resin selected to impart a cushioning effect to said top surface under conditions suitable for the injection molding of the elongate body; releasing the injection molded elongate body from the mold.

11. The process for constructing a wrist rest of claim 10, wherein, the polymeric resin is a polyvinyl chloride.

12. The process for constructing a wrist rest of claim 10, wherein said web includes fastening means for fastening said wrist rest to a keyboard tray assembly.

13. A wrist rest for supporting the writs of a user of a keyboard or similar device for data entry, said wrist rest comprising:
An elongated plastic body compatibly contoured to support the writs of a user, further comprising a front edge, a rear edge, distal end portions, and a top surface.
A center portion of said plastic body comprising a web structure;
A bottom portion of said plastic body comprising the bottom of said web structure;
At least one receiver located about said bottom portion wherein said receiver is compatibly formed to provide for the receipt of a fastener for mounting said plastic body to the surface of a keyboard tray;
Further comprising a plastic body formed from a selected plastic resin.

14. A wrist rest of claim 13 where the plastic resin is a polyvinyl chloride.

15. A wrist rest of claim 13 where the plastic resin is selected for a durometer hardness between shore A 40 to shore A 70.
